(19) United States
(12) Patent Application Publication
(10) Pub. No.: US 2026/0331677 A1
(43) Pub. Date: Oct. 22, 2026

(54) ARRANGEMENT FOR A VEHICLE, VEHICLE WITH SUCH AN ARRANGEMENT AND ASSOCIATED METHOD FOR FIXING AND GROUNDING A TRACTION BATTERY IN A VEHICLE

(71) Applicant: FLEXIS, BOULOGNE-BILLANCOURT (FR)

(72) Inventor: Guillaume MICHAUD, GUYANCOURT (FR)

(21) Appl. No.: 19/650,833

(22) Filed: Apr. 17, 2026

(30) Foreign Application Priority Data
Apr. 22, 2025 (FR) FR2504244

(51) Int. Cl. H01M 50/262; B60K 1/04; B60L 50/64; H01M 50/224; H01M 50/242; H01M 50/249

(52) U.S. Cl. CPC H01M 50/262; B60K 1/04; B60L 50/64; H01M 50/224; H01M 50/242; H01M 50/249; H01M 2220/20

(57) ABSTRACT

An arrangement for a vehicle includes: a traction battery including a metallic casing, the casing including a first fixing orifice, a structural element including a second fixing orifice, the structural element being metallic and coated with a coating layer, and a fixing and grounding bolt of the traction battery. The bolt includes: a nut having been welded to the structural element prior to application of the coating layer, and a screw including a head and a shank including a fixing portion and a cleaning portion. The cleaning portion includes at least two grooves defined axially.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to the fixing and grounding of a traction battery in a vehicle. In particular, the present disclosure relates to an arrangement for a vehicle and to a vehicle comprising such an arrangement. Furthermore, the present disclosure also relates to a method for fixing and grounding a traction battery in a vehicle.

### BACKGROUND

The grounding of a traction battery is essential to ensure the proper operation and safety of a vehicle, notably, an electric vehicle, powered by this battery.

By “grounding”, what is meant here is the definition of an electrical connection of the traction battery to a reference potential.

To this end, it is known to arrange at least one ground cable connecting the traction battery to a piece of the body or bodywork.

Such a ground cable generally comprises an extra length in order to avoid breakage thereof in the event of an accidental impact, for example frontal, lateral or rear. This extra length thus allows to ensure electrical continuity between the body and the traction battery, thus guaranteeing safety.

However, this solution is not entirely satisfactory.

Indeed, such a ground cable presents a very large cross-section, notably of about 30 mm². The extra length added for safety reasons therefore results in a non-negligible additional cost.

Furthermore, assembling such a grounding cable is generally not very ergonomic, since it must be carried out under the body.

### SUMMARY

One of the aims of the present disclosure is then to overcome these drawbacks, and in particular to propose a means for electrically grounding a traction battery that is economical, reliable and easy to assemble.

To this end, the present disclosure has as its object an arrangement for a vehicle, notably for an automotive vehicle and especially an electric vehicle, comprising:
a traction battery comprising a metallic casing, the casing comprising at least one first fixing orifice centered on a fixing axis;
a structural element comprising at least one second fixing orifice centered on an orifice axis coincident with the corresponding fixing axis, the structural element being metallic and coated with a coating layer, in particular a paint layer, and
at least one fixing and grounding bolt of the traction battery, the bolt comprising:
a nut centered on the corresponding fixing axis and having been welded to the structural element prior to application of the coating layer, and
a screw comprising a head and a shank extending according to a shank axis coincident with the fixing axis, the shank comprising a fixing portion and a cleaning portion,
the fixing portion of the shank extending according to the shank axis between the head and
the cleaning portion, the cleaning portion comprising at least two grooves defined axially according to the shank axis.

According to other advantageous aspects of the present disclosure, the arrangement comprises one or more of the following features, taken alone or according to any technically possible combinations:
The casing comprises a right side and a left side opposite according to a transverse direction, the casing comprising at least two first fixing orifices per side, and preferably at least five first fixing orifices per side, each first fastening orifice defining a corresponding fixing axis, in particular perpendicular to the transverse direction, the structural element comprising a corresponding second fixing orifice for each of the first fixing orifices, the arrangement comprising a corresponding bolt for each first fixing orifice.
The, or each screw is coated with a conductive coating.
The grooves of the cleaning portion are straight and notably extend parallel to the shank axis.
The or each cleaning portion comprises at least four grooves, preferably distributed in a uniformly circular manner around the shank axis.
The or each screw is a screw of size M10 to M14.

The present disclosure also relates to a vehicle, notably an automotive vehicle and especially an electric vehicle, comprising an arrangement such as described above.

The present disclosure also relates to a method for fixing and grounding a traction battery in a vehicle, the method comprising the following steps:
a. providing a traction battery comprising a metallic casing, the casing comprising at least one first fixing orifice centered on a fixing axis,
b. providing a structural element comprising at least one second fixing orifice centered on an orifice axis, the structural element being metallic,
c. providing at least one bolt comprising a nut and a screw, the screw comprising a shank extending according to a shank axis and comprising a fixing portion and a cleaning portion comprising at least two grooves defined axially according to the shank axis,
d. welding the nut to the structural element so as to center it on the orifice axis of the corresponding second fixing orifice,
e. applying the coating layer, in particular a paint layer, to the structural element and the nut,
f. arranging the casing so that the fixing axis of the first fixing orifice or of each first fixing orifice coincides with the orifice axis of the corresponding second fixing orifice of the structural element, and
g. screwing the or each screw into the corresponding nut.

According to other advantageous aspects of the present disclosure, the method comprises one or more of the following features, taken alone or according to any technically possible combination:

Step e) is carried out by cataphoresis.

Step d) is carried out by resistance welding.

### BRIEF DESCRIPTION OF THE DRAWINGS

The present disclosure will appear more clearly on reading the following description, given solely by way of non-limiting example, and made with reference to the drawings in which:

FIG. 1 is a schematic view of a vehicle according to the present disclosure,

FIG. 2 is a schematic view of an arrangement according to the present disclosure,

FIG. 3 is a perspective view of a zone A of the arrangement of FIG. 2, and

FIG. 4 is a sectional view of FIG. 3.

### DETAILED DESCRIPTION

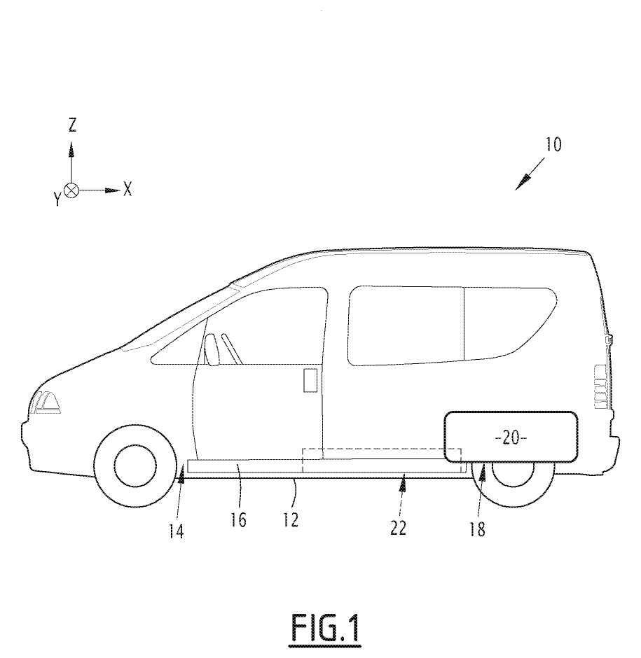

FIG. 1 shows a vehicle 10 according to the present disclosure.

The vehicle 10 is, for example, an automotive vehicle, in particular a utility vehicle, notably a light utility vehicle.

In particular, the vehicle 10 is intended for transporting goods, such as parcels, and/or passengers.

The vehicle 10 is, for example, a van, as illustrated in FIG. 1.

The vehicle 10 is preferably an electric vehicle.

For clarity, an orthonormal frame XYZ is defined comprising a longitudinal direction X, a transverse direction Y and a vertical direction Z. The longitudinal direction X extends according to the direction of travel of the vehicle 10 and corresponds to a front-rear axis of the vehicle 10. The transverse direction Y is perpendicular to the longitudinal direction X and corresponds to a left-right axis of the vehicle 10. The vertical direction Z is perpendicular to the longitudinal direction X and to the transverse direction Y and corresponds to a bottom-top axis of the vehicle 10.

The terms “top” and “bottom” are defined with respect to the vertical direction Z corresponding to the height of the vehicle. The terms “left”, “right”, “front” and “rear” are defined with respect to the usual direction of travel of the vehicle.

For example, the vehicle 10 comprises a chassis 12 and a body 14 fixed to the chassis 12.

The body 14 comprises, for example, a plurality of structural parts 16, such as a floor, pillars or body panels for example.

Preferably, the vehicle 10 comprises a powertrain 18, for example arranged at the rear of the vehicle 10.

In particular, the powertrain 18 comprises, for example, a motor 20, notably electric.

The vehicle 10 comprises an arrangement 22 according to the present disclosure.

The arrangement 22 comprises a traction battery 24, a structural element 26 and at least one fixing and grounding bolt 28 of the traction battery 24.

For example, the arrangement 22 is arranged in a lower part of the vehicle 10.

The traction battery 24 is preferably able to store the energy necessary to supply the motor 20.

In particular, the traction battery 24 forms notably part of the power train of the vehicle 10.

The traction battery 24 presents, for example, a terminal voltage of 800 V.

The traction battery 24 comprises a metallic casing 30 and preferably a plurality of modules 32, notably assembled in said casing 30.

Each module 32 comprises, for example, a plurality of electrochemical cells.

For example, the metallic casing 30 defines a protective enclosure in which the modules 32 are housed.

The metallic casing 30 is for example made of aluminum, and in particular uncoated aluminum.

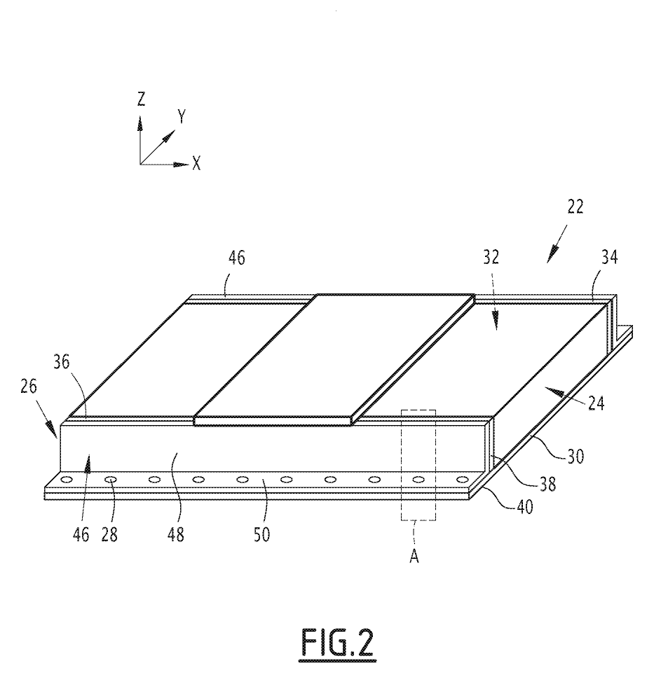

As is visible in FIG. 2, the casing 30 comprises, for example, a right side 34 and a left side 36, in particular opposite according to the transverse direction Y.

For example, each of the right 34 and left 36 sides comprises a flat portion 38, in particular vertical, and a horizontal support 40 extending in an external transverse protrusion from the flat portion 38.

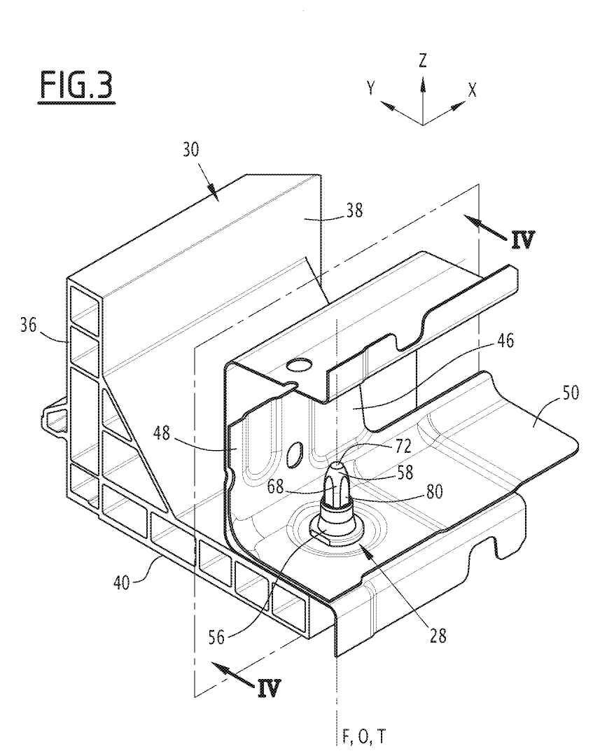

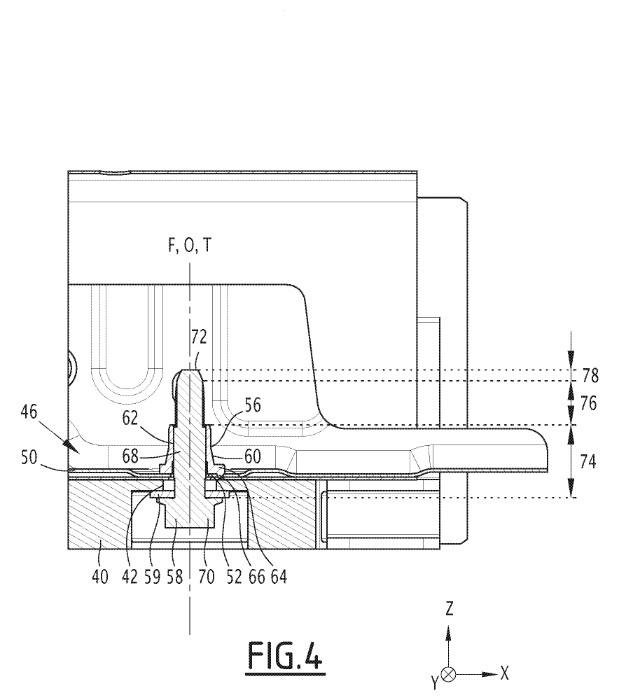

FIGS. 3 and 4 illustrate a particular example embodiment of a part of the left side 36 of the casing 30, notably in the zone A defined in FIG. 2.

As is visible in the figures, the casing 30 comprises at least one first fixing orifice 42, and preferably a plurality of first fixing orifices 42.

Each first fixing orifice 42 is, in particular, defined on the right side 34 or the left side 36 of the casing 30, and preferably is provided on the corresponding horizontal support 40 as is visible in FIG. 3.

Advantageously, the casing 30 comprises at least two first fixing orifices 42 per side 34, 36, and preferably at least five first fixing orifices 42 per side 34, 36, and even more preferably between 6 and 12 first fixing orifices 42 per side 34, 36.

In particular, on each of the two sides 34, 36, the corresponding first fixing orifices 42 are aligned with each other notably according to the longitudinal direction X.

More precisely, the first fixing orifices 42 define, on each of the two sides 34, 36, a longitudinal row, notably defined on the corresponding horizontal support 40.

Preferably, on each of the sides 34, 36, the first fixing orifices 42 are distributed along the same longitudinal row, for example in a uniform manner, in other words, at equal distance from one another, or at different intervals between them.

The first fixing orifices 42 are, for example, all identical to one another.

Each first fixing orifice 42 is centered on a fixing axis F.

The fixing axis F of each first fixing orifice 42 is notably perpendicular to the transverse direction Y, and more precisely parallel to the vertical direction Z, as is visible in FIGS. 3 and 4.

Each first fixing orifice 42 is notably a through-orifice, as is visible in FIG. 4.

For example, each first fixing orifice 42 is circular.

More precisely, each first fixing orifice 42 presents a diameter between 8 mm and 15 mm, and even more precisely between 10 mm and 14 mm.

The structural element 26 notably forms part of the body 14 of the vehicle 10.

More precisely, the structural element 26 comprises at least one part 46 chosen from among the structural parts 16 of the body 14, as is visible in FIG. 2.

In the example illustrated in FIG. 2, the structural element 26 comprises two parts 46.

In particular, the structural element 26 comprises, for example, a right part facing the right side 34 of the casing 30 and a left part facing the left side 36 of the casing 30.

FIGS. 3 and 4 illustrate one particular example embodiment of a part of one of the left parts 46 of the structural element 26 facing the left side 36 of the casing 30, at zone A of FIG. 2.

For example, in the particular embodiment illustrated in the figures, each part 46 of the structural element 26 comprises a vertical portion 48, notably extending according to the vertical direction Z, and a horizontal portion 50 extending in an external transverse protrusion from the vertical portion 48.

In particular, the horizontal portion 50 of the part 46 is facing, and more precisely against, the horizontal support 40 of the corresponding side 34, 36 of the casing 30.

For example, each of the parts 46 is formed by superposition of two sheets, as is visible in FIGS. 3 and 4.

The structural element 26, and more precisely each of the parts 46, is metallic and coated with a coating layer.

The structural element 26, and more precisely each of the parts 46, is made for example of steel.

The coating layer is, for example, an electrically insulating layer, in particular a paint layer, notably deposited by cataphoresis.

The structural element 26 comprises at least one second fixing orifice 52, and preferably a plurality of second fixing orifices 52.

Each second fixing orifice 52 of the structural element 26 is, in particular, provided in one of the parts 46 of the structural element 26, and notably in the corresponding horizontal portion 50.

Advantageously, the structural element 26 comprises a corresponding second fixing orifice 52 for each first fixing orifice 42 of the casing 30.

More precisely, each second fixing orifice 52 of the structural element 26 extends facing one of the first fixing orifices 42 of the casing 30.

For example, the structural element 26 comprises the same number of fixing orifices 52 as the casing 30, and notably at least two second fixing orifices 52 per part 46, and preferably at least five second fixing orifices 52 per part 46, and even more preferably between 6 and 12 second fixing orifices 52 per part 46.

In particular, on each of the two parts 46, the corresponding second fixing orifices 52 are aligned with each other notably according to the longitudinal direction X.

More precisely, the second fixing orifices 52 define, on each of the two parts 46, a longitudinal row, notably defined on the corresponding horizontal portion 50.

Preferably, the second fixing orifices 52 are distributed along the same longitudinal row, for example uniformly, in other words, at equal distance from one another, or at different intervals between them. The second fixing orifices 52 are for example all identical to one another.

Each of the second fixing orifices 52 of the structural element 26 is centered on an orifice axis O, notably coincident with the fixing axis F of the corresponding first fixing orifice 42 of the casing 30.

The orifice axis O of each second fixing orifice 52 is notably perpendicular to the transverse direction Y, and more precisely parallel to the vertical direction Z, as is visible in FIGS. 2 to 4.

Each second fixing orifice 52 of the structural element 26 is notably a through-orifice, as is visible in FIG. 4.

For example, each second fixing orifice 52 is circular.

More precisely, each second fixing orifice 52 presents a diameter between 8 mm and 15 mm, and even more precisely between 10 mm and 14 mm.

The arrangement 22 comprises at least one fixing and grounding bolt 28 of the traction battery 24, and preferably a plurality of bolts 28.

For example, the arrangement 22 comprises at least four bolts 28, and preferably at least 10 bolts 28, and even more preferably between 12 and 24 bolts 28.

More precisely, the arrangement 22 comprises a corresponding bolt 28 for each first fixing orifice 42 of the casing 30, and in particular for each pair formed by one of the first fixing orifices 42 of the casing 30 and the corresponding second fixing orifice 52 of the structural element 26.

Each bolt 28 is, in particular, configured to fasten the traction battery 24, and in particular its casing 30, to the structural element 26.

More precisely, each bolt 28 fixes together one of the sides 34, 36 of the casing 30 to the corresponding part 46 of the structural element 26, notably by connecting the pair formed by one of the first fixing orifices 42 of the casing 30 and the corresponding second fixing orifice 52 of the structural element 26.

Even more precisely, as is visible in FIGS. 3 and 4, each bolt 28 fastens together the horizontal support 40 of one of the sides 34, 36 of the casing 30 to the horizontal portion 50 of the corresponding part 46 of the structural element 26.

Each bolt 28 is also configured to ground the traction battery 24.

In particular, as will be explained in more detail later, each bolt 28 is configured to define, notably by means of the structural element 26, an electrical connection between the traction battery 24 and the ground, in particular a reference potential.

Each bolt 28 comprises a nut 56 and a screw 58.

Each bolt 28 also comprises for example a washer 59.

The nut 56 is centered on the corresponding fixing axis F.

More precisely, in a conventional manner, the nut 56 comprises a ring 60 with a central tapped hole 62, in other words, provided with an internal thread.

The central tapped hole 62 is notably centered on the corresponding fixing axis F.

The ring 60 presents for example a frustoconical cross-section, as is visible in FIG. 4.

Preferably, the ring 60 also comprises a flange 64, in particular in a lower part of the nut 56.

The nut 56 is made of a metallic material, such as steel for example.

The nut 56 was welded to the structural element 26 prior to application of the coating layer.

More precisely, the nut 56, and notably the flange 64 of the ring 60, was welded to the corresponding part 46, and notably to its horizontal portion 50, before deposition of the coating layer.

For example, the nut 56 was welded to the part 46 by a metal-to-metal weld, notably by resistance welding.

This welding of the nut 56 to the part 46 before application of the coating layer defines, in particular, a metallic weld bead 66 connecting the two elements, as is visible in FIG. 4.

The screw 58 of each bolt 28 is configured to cooperate with the corresponding nut 56.

The screw 58 of each bolt 28 is for example metallic, notably steel.

Advantageously, each screw 58 is coated with a conductive coating, in particular to enhance the electrical conductivity of said screw 58.

The conductive coating is for example an anti-corrosion coating with high electrical conductivity properties.

The or each screw 58 is, more particularly, a screw of size M10 to M14.

The screw 58 of each bolt 28 comprises a shank 68 and a head 70.

The shank 68 extends according to a shank axis T, notably between the head 70 and a free end 72.

The shank axis T is preferably coincident with the corresponding fixing axis F.

The shank 68 presents, in particular, a diameter corresponding substantially to the diameter of the hole 62 of the nut 56.

For example, where the screw 58 is a screw of size M10 to M14, the shank 68 presents a diameter between 10 mm and 14 mm.

The shank 68 of each screw 58 comprises a fixing portion 74 and a cleaning portion 76.

Preferably, the shank 68 of each screw 58 also comprises a tip 78, for example a frustoconical tip or a cylindrical pilot tip.

The shank 68 of each screw 58 is preferably divided according to the shank axis T between the fixing portion 74, the cleaning portion 76 and the tip 78; the cleaning portion 76 extending between the fixing portion 74 and the tip 78.

The fixing portion 74 extends according to the shank axis T between the head 70 and the cleaning portion 76.

As is visible in FIG. 4, the fixing portion 74 of the shank 68 of each screw 58 extends, in particular, through the corresponding first fixing orifice 42, through the corresponding second fixing orifice 52 and into the nut 56, notably into the tapped hole 62.

The fixing portion 74 of the shank 68 presents for example an external thread cooperating with the internal thread of the tapped hole 62 of the nut 56.

As is visible in FIG. 4, the cleaning portion 76 of the shank 68 of each screw 58 extends, for example, according to the shank axis T between the cleaning portion 76 and the tip 78.

Preferably, the cleaning portion 76 of the shank 68 of each screw 58 extends at least partly outside the nut 56.

The cleaning portion 76 of the shank 68 presents, for example, a length, measured according to the shank axis T, between 5 mm and 15 mm, and preferably between 8 mm and 12 mm.

Each cleaning portion 76 comprises at least two grooves 80 defined axially according to the shank axis T.

Each cleaning portion 76 comprises at least four grooves 80, preferably distributed in a uniformly circular manner around the shank axis T.

In the particular embodiment of FIG. 3, the cleaning portion 76 comprises four grooves 80 spaced 90° apart from one another.

Each groove 80 is notably provided on the cleaning portion 76, in particular over the entire length thereof.

More precisely, each groove 80 defines a recess in the cleaning portion 76. In particular, the diameter of the cleaning portion 76 is smaller at each groove 80.

Preferably, each groove 80 presents a cross-section, notably taken in a plane XY, in the shape of a circular arc. Alternatively, each groove 80 defines a flat.

In the embodiment illustrated in FIG. 3, the grooves 80 are straight, and notably extend parallel to the shank axis T.

Alternatively, the grooves 80 extend in a partial helical manner, in other words, in an inclined manner but not over a complete circumference of the shank 68.

The tip 78 extends notably between the cleaning portion 76 and the free end 72.

The tip 78 is for example a frustoconical tip or a cylindrical pilot tip.

A method for fixing and grounding a traction battery 24 in a vehicle 10 will now be described.

The method comprises a step a) of providing a traction battery 24, in particular a traction battery 24 as described above.

More particularly, the provided traction battery 24 comprises a metallic casing 30.

The casing 30 comprises at least one first fixing orifice 42 centered on a fixing axis F, and preferably a plurality of first fixing orifices 42 such as described above.

The method also comprises a step b) of providing a structural element 26, in particular a metallic structural element 26 such as described above.

For example, the structural element 26 comprises at least one metallic part 46, notably such as described above.

In particular, during this step b), the structural element 26 is not covered with any coating layer.

The structural element 26 comprises at least one second fixing orifice 52 centered on an orifice axis O, and preferably a plurality of second fixing orifices 52 such as described above.

Preferably, the structural element 26 comprises the same number of fixing orifices 52 as the casing 30.

The method further comprises a step c) of providing a bolt 28, in particular, a bolt 28 such as described above.

Preferably, step c) comprises providing a plurality of bolts 28, notably one bolt 28 per first fixing orifice 42.

As described above, each provided bolt 28 comprises notably a nut 56 and a screw 58.

Each provided screw 58 comprises, in particular, a shank 68 extending according to an axis T and comprising a fixing portion 74 and a cleaning portion 76 with at least two grooves 80 such as described above.

The method then comprises a step d) of welding each nut 56 to the structural element 26, and in particular, so as to center it on the orifice axis O of the corresponding second fixing orifice 52.

More precisely, the nut 56 is welded to the corresponding part 46.

Even more precisely, the flange 64 of the ring 60 of each nut 56 is welded to the horizontal portion 50 of the corresponding part 46.

Preferably, after welding, the central tapped hole 62 of the nut 56 is centered on the orifice axis O of the second fixing orifice 52.

Step d) is carried out by a metal-to-metal weld.

Advantageously, notably due to its high reproducibility and simplicity, step d) is carried out by resistance welding.

In particular, during welding of each nut 56 to the structural element 26, a metallic weld bead 66 is formed.

The method then comprises a step e) of applying a coating layer, in particular a paint layer, to the structural element 26 and the nut(s) 56.

For example, the coating layer is applied to the or each part 46, and also to the or each nut 56 welded to said parts 46.

Advantageously, notably due to the uniformity and quality of the deposition, step e) is carried out by cataphoresis.

Then, the method comprises a step f) of arranging the casing 30 of the traction battery 24, in particular so that the fixing axis F of each first fixing orifice 42 coincides with the orifice axis O of the corresponding second fixing orifice 52 of the structural element 26.

The method then comprises a step g) of screwing each screw 58 into the corresponding nut 56.

During this screwing step, the free end 72, and notably the tip 78, of the shank 68 is, for example, first inserted into the hole 62 of the nut 56, according to the fixing axis F.

Then, the cleaning portion 76 is inserted, and notably screwed, into the nut 56. During said screwing, by means of the grooves 80, deposits of the coating layer in the hole 62 of the nut are advantageously evacuated.

Following this screwing, the fixing portion 74 of the shank 68 of the screw extends, for example, through the first fixing orifice 42, through the corresponding second fixing orifice 52 and into the corresponding nut 56.

Notably, the fixing portion 74 and the hole 62 are preferably in metal-to-metal contact with each other, due to the cleaning of the hole 62 by the cleaning portion 76.

Thus, following such a method, the traction battery 24 is fixed to the structural element 26 by the bolt(s) 28.

Furthermore, following such a method, the traction battery 24 is grounded.

In particular, each bolt 28 defines, notably by means of the structural element 26, an electrical connection between the traction battery 24 and ground, in particular a reference potential.

More precisely, the electric current passes from the traction battery 24 to the metallic screw 58, then into the corresponding nut 56 and then into the structural element 26, notably by the metallic weld bead 66. The structural element 26 being a body element, it thus enables the grounding of the traction battery 24.

The bolt(s) 28 thus play(s) both a fixing role and also a grounding role for the traction battery 24.

Thus, they allow to dispense with the use of a cable with an extra length for grounding and its associated disadvantages.

The arrangement 22 according to the present disclosure is therefore particularly advantageous in that it is economical and ensures ergonomic assembly.

Furthermore, due to the dual functionality of the bolt(s) 28, such an arrangement notably presents a reduced number of parts.

In addition, the definition of the grooves 80 in the cleaning portion 76 of each screw 58 ensures satisfactory evacuation of the coating layer in the nut 56, and thus optimal electrical conductivity between the nut 56 and the screw 58.

The arrangement 22 with a plurality of bolts 28 provides redundancy of fixing and grounding, which allows to ensure grounding of the traction battery 24 even if some of the bolts 28 are destroyed, notably following an accidental impact.

This redundancy ensures greater reliability of the arrangement 22 and therefore greater safety.

What is claimed is:

1. An arrangement for a vehicle comprising:
a traction battery comprising a metallic casing, the metallic casing comprising at least one first fixing orifice centered on a fixing axis;
a structural element comprising at least one second fixing orifice centered on an orifice axis coincident with the fixing axis, the structural element being metallic and coated with a coating layer; and
at least one fixing and grounding bolt of the traction battery, the at least one fixing and grounding bolt comprising:
a nut centered on the fixing axis and having been welded to the structural element prior to application of the coating layer; and
a screw comprising a head and a shank extending according to a shank axis coincident with the fixing axis, the shank comprising a fixing portion and a cleaning portion,
wherein the fixing portion of the shank extends according to the shank axis between the head and the cleaning portion, and
wherein the cleaning portion comprises at least two grooves defined axially according to the shank axis.

2. The arrangement according to claim 1, wherein the coating layer is a paint layer.

3. The arrangement according to claim 1, wherein the metallic casing comprises a right side and a left side facing according to a transverse direction, the metallic casing comprising at least two first fixing orifices per side, each first fixing orifice defining a corresponding fixing axis,
the structural element comprising a corresponding second fixing orifice for each of the at least two first fixing orifices, and
the arrangement comprising a corresponding bolt for each first fixing orifice.

4. The arrangement according to claim 3, wherein the metallic casing comprises at least five first fixing orifices per side.

5. The arrangement according to claim 3, wherein the corresponding fixing axis of each first fixing orifice is perpendicular to the transverse direction.

6. The arrangement according to claim 1, wherein the screw is coated with a conductive coating.

7. The arrangement according to claim 1, wherein the at least two grooves of the cleaning portion are straight.

8. The arrangement according to claim 7, wherein the at least two grooves of the cleaning portion extend parallel to the shank axis.

9. The arrangement according to claim 1, wherein the cleaning portion comprises at least four grooves.

10. The arrangement according to claim 9, wherein the at least four grooves are distributed in a uniformly circular manner around the shank axis.

11. The arrangement according to claim 1, wherein the screw is size M10 to M14.

12. A vehicle comprising the arrangement according to claim 1.

13. A method for fixing and grounding a traction battery in a vehicle, the method comprising the following steps:
a. providing a traction battery comprising a metallic casing, the metallic casing comprising at least one first fixing orifice centered on a fixing axis;
b. providing a structural element comprising at least one second fixing orifice centered on an orifice axis, the structural element being metallic;
c. providing at least one bolt comprising a nut and a screw, the screw comprising a shank extending according to a shank axis and comprising a fixing portion and a cleaning portion comprising at least two grooves defined axially according to the shank axis;
d. welding the nut to the structural element so as to center it on the orifice axis of a corresponding second fixing orifice;
e. applying a coating layer to the structural element and the nut;
f. arranging the metallic casing so that the fixing axis of the at least one first fixing orifice or of each first fixing orifice coincides with the orifice axis of the corresponding second fixing orifice of the structural element; and
g. screwing the screw into the corresponding nut.

14. The method according to claim 13, wherein step e) is carried out by cataphoresis.

15. The method according to claim 13, wherein step d) is carried out by resistance welding.
